(19) United States
(12) Patent Application Publication
(10) Pub. No.: US 2020/0238576 A1
(43) Pub. Date: Jul. 30, 2020

(54) HEATING BLANKET AND METHOD FOR USE

(71) Applicant: GENERAL NANO LLC, Cincinnati, OH (US)

(72) Inventors: Larry Allen Christy, Cincinnati, OH (US); Joseph E. Sprengard Jr., Cincinnati, OH (US); Jae Hak Kim, Mason, OH (US); Chaminda Jayasinghe, Cincinnati, OH (US); Thomas J. Sorenson, Cottonwood Heights, UT (US)

(21) Appl. No.: 16/755,281

(22) PCT Filed: Oct. 11, 2018
(86) PCT No.: PCT/US2018/055364

§ 371 Date: Apr. 10, 2020

Related U.S. Application Data
(60) Provisional application No. 62/570,803, filed on Oct. 11, 2017.

(51) Int. Cl. B29C 35/02; B29C 70/44; B29C 70/54; H05B 3/14; H05B 3/34

(52) U.S. Cl. CPC B29C 35/02; B29C 70/44; B29C 70/54; H05B 2214/04; H05B 3/34; B29C 2035/0211; H05B 2203/003; H05B 3/145

(57) ABSTRACT

A heating blanket (18), useful for debulking and/or curing composite materials, comprising at least one heating element comprising a carbon nanotube (CNT) structured layer defining an electrically conductive pathway having a first end and a second end and a first electrical terminal (19) electrically coupled to the first end and a second electrical terminal (21) electrically coupled to the second end, and an elastomeric outer covering, encasing the at least one heating element, wherein the at least one heating element is responsive to an electromotive force applied across the first and the second electrical terminals to produce heat.

### CROSS-REFERENCE TO RELATED APPLICATIONS

The present application is the National Stage of International Application No. PCT/US2018/055364 filed Oct. 11, 2018, which claims the benefit of U.S. Provisional Application No. 62/570,803 filed Oct. 11, 2017, the disclosures of which are incorporated herein by reference in their entireties.

### TECHNICAL FIELD

The present disclosure is related to tools for manufacturing component parts from laminated prepregs.

### BACKGROUND

Aerospace vehicles, e.g., airplanes, helicopters, spacecraft, and the like, are being designed and manufactured with greater percentages of composite materials. The use of composites may increase the strength, decrease the weight, provide improved functional performance properties, are often quicker to manufacture with reduced number of parts, and provide a longer service life of various components of the aerospace vehicle. For example, composite materials can be used in the construction of a variety of component parts including fuselages, wings, winglets, slats, spoilers, ailerons, flaps, horizontal and vertical stabilizers, rudders, etc. in airplanes. Similarly, composite materials can be used in the construction of rotor blades, stabilizers bars, tail booms, and elevators in helicopters, just to provide some examples.

Many of these parts have complex shapes or compound curves and/or sharp edges that are designed to allow these vehicles to move through the air more efficiently or in a particular manner. For example, military aircraft commonly employ stealth technology whereby these aircraft are designed to avoid detection using a variety of technologies that reduce reflection and/or emission of radar, infrared, visible light, radio frequency and audio, giving rise to even more unique shapes with even more pronounced or sharp edges.

Composite materials are engineered materials made from two or more constituent materials, each with significantly different physical and/or chemical properties, which remain separate and distinct within the finished product but which cooperate to form a material with enhanced physical properties. Composite materials, i.e., fiber reinforced composites, can consist of various types of fibers, including aramid (e.g., Kevlar®), carbon fiber, fiberglass, glass, graphene, carbon nanotube, silicon carbide, polyester, etc., held together in a resin. The resin can be epoxy, bismaleimide (BMI), acrylonitrile butadiene styrene (ABS), acetal, acrylic, cellulose acetate butyrate (CAB), chlorinated polyvinyl chloride (CPUC), ethylene chlorobifluoroethylene (ECTFE), Fluorosint, polyamide (nylon), polyether ether ketone (PEEK), polyethylene terephthalate (PET), polycarbonate, polypropylene, polysulfone, polyphenylene (PPS), polyvinyl chloride (PVC), polyvinyl alcohol (PVA), polyvinylidene fluoride or polyvinylidene difluoride (PVDF), polytetrafluoroethylene (PTFE), Tecator, styrene acrylic, phenoxy, polyurethane, or ultrahigh molecular weight polyethylene (UHMPE or UHMW), to name some examples.

Further, one type of uncured fiber reinforced composite material is often referred to as a “prepreg.” For example, prepreg is the term commonly applied to a carbon fiber fabric that has been pre-impregnated with a resin, typically epoxy, that already includes the proper curing agent and is ready to be laid into a mold.

These prepreg materials are often used with molds, i.e., tools, to build or fabricate the aforementioned parts. The tools are typically disposed on the windswept or windward side of the part, which is to say, the first layer of material placed into the tool typically goes, for example, to the outside of the aircraft whereas subsequent layers are more inboard or interior to the aircraft. This is done to provide the smoothest exterior surface for airflow. Many layers of prepreg material are often laminated together to provide the requisite strength and load carrying capability.

When two or more layers of prepreg material are placed into a tool, air can become trapped between the layers. Oftentimes, trapped air or gas cannot be seen and, if not removed or forced out, results in voids or air or gas in pockets in the resulting laminate, which can compromise the structural integrity and/or reduces the strength of a part and can lead to part failure. With aerospace vehicles, part failures can be catastrophic in nature and, many times, fatal. Further, as successive layers are added, there is a greater opportunity for trapped air or gas and the laminate becomes less “consolidated,” and “bulky.” A laminate that is less consolidated or unevenly consolidated, e.g., non-homogenous, is also not as strong and can likewise fail with similar consequences.

“Debulking” is the process that removes air or gas from the laminate, and ensures even consolidation of the material before final curing of the resin. Debulking processes can use heat alone or a combination of heat and pressure. When parts require many layers of prepreg material to provide the requisite strength and load carrying capability, debulking is typically performed every five to ten layers, depending on the complexity and/or shape of the part, these debulked five to ten layers portions of a part referred to hereinafter as “subpart.”

In a non-limiting example, a tool receives a number of layers of prepreg material to construct a part or subpart. A flexible, air impermeable film or sheet is then placed over the laminate material and sealed against the tool, around the periphery of the part or subpart, forming a container that defines a space, with a sealable opening. A vacuum is then applied to the sealed space of the container to evacuate air or gas within the space, to allow the atmospheric pressure outside the container to push or press the layers of prepreg material together to force out trapped air or gas from between the layers of the laminated material. The tool is then placed in an oven or autoclave to warm and soften the resin and further consolidate the laminate. At some stage, the laminated prepregs of the part or subpart are warmed, e.g., to 100-200 degrees Fahrenheit (° F.) (38-93 degrees Celsius (° C.)), sufficient to debulk the prepreg material. Preferably during debulk, the prepregs are heated to a temperature that does not cure the resin. Again, depending on the part program, i.e., the number, type and order of layers in the part design, this can be required every five to ten plies depending on the complexity and/or shape of the part.

There are several disadvantages to conventional the debulking process. For one, aerospace component parts of this nature are typically built in clean facilities or cleanrooms, because foreign object debris (FOD) can compromise the structural integrity and/or strength of parts. Thus, prepreg laminates are often placed or laid up onto a tool in a clean environment, e.g., the cleanroom, and then the tool is moved to an oven or autoclave to warm the resin for debulking. This process must be repeated, sometimes over and over again, when parts require many layers and/or are complex. This is time consuming and expensive, having to move the tools with the laid-up laminates or subparts between the clean facilities and the autoclaves, and allows additional opportunities for the entry of foreign objects.

Further, as the size of the parts increase, this process either becomes even more costly and time consuming or, at some point, becomes completely impractical. Large ovens sufficient to large component parts are expensive to own and operate and take time to come up to warming temperature, and cool, when opened and closed repeatedly. Parts and the associated tools used to build them can even become so large that it becomes infeasible to move them at all; for example, a wing of a large passenger airplane. The tool used for such an airplane wing is also very expensive and complex, and there is a risk of damage to the tool if it were to be moved,

With larger parts, metallic filament-based heat blankets are used to provide the necessary heat for debulking but they too have disadvantages. Generally, metallic filament based heat blankets are built in multiple layers, each layer having a particular function, and, as a result, are stiff and not particularly

For example, a metallic filament based heat blanket generally includes a central heater circuit comprised of a precision placed filament wire or precision-cut foil. Precise placement is required to provide uniform heat across the blanket and ensure even, uniform and consistent consolidation of prepreg materials during the debulk step. With repeated heat cycling, the filament wire can age and become brittle (work hardened), and results in breaking when flexed, especially when flexed in multiple cycles of use. To prevent breakage and insulate the filament wire, the heater circuit is sandwiched between two layers of fiberglass reinforced silicone rubber. Next, a control or supervisory circuit and ground grid is added on opposite sides of the heater circuit, The supervisory circuit is used with a dedicated control panel to monitor and regulate the operating temperature of the blanket. Finally, two outer layers of fiberglass reinforced silicone rubber are used to enclose and protect the supervisory circuit and ground grid, and further protect the filament wire.

Such metallic filament based heat blankets work well enough on tooling which is relatively flat or planar. However, these blankets become less and less satisfactory as the shape of the part to be laminated becomes more complex, incorporating, for example, reentrant portions, recesses, or tight-radius inside contours. Further, since the filaments have to be precision placed, these blankets are not easily scaled to larger parts, becoming quite expensive as they become larger.

Accordingly, those skilled in the art continue with research and development efforts in the field of tools for use with composite materials.

### SUMMARY

The present invention provides a heating blanket useful for example, for debulking and/or curing composite materials, including at least one heating element and an elastomer outer covering encasing the at least one heating element. The at least heating element comprises a carbon nanotube tube (CNT) structured layer defining an electrically conductive pathway having a first end and a second end, and a first electrical terminal electrically coupled to the first end and a second electrical terminal coupled to the second end. The at least one heating element is responsive to an electromotive force applied across the first and the second electrical terminals to produce heat.

In some embodiments, the elastomeric outer covering is cured so that the heating blanket forms a resilient three-dimensional shape that follows the shape of a caul tool associated with a part or a part that is to be produced.

In some other embodiments, the CNT structured layer comprises a CNT sheet formed over a porous carrier material.

In some other embodiments, the CNT structured layer has an upper surface and a lower surface and the at least one heating element further comprises a thermoplastic film disposed against at least one of the upper surface and the lower surface of the CNT structured layer.

In some other embodiments, the flexural strength of the CNT structured layer is equal to or greater than the flexural strength of a thermoplastic film disposed against the CNT structured layer,

In some other embodiments, the flexural strength of the CNT structured layer is 40 to 270 Megapascals (MPa) and flexural modulus of the CNT structured layer is 0.7 to 7.5 Gigapascals (GPa) as measured in accordance with ASTM D790.

In some other embodiments, the thickness of the at least one heating element is less than 0.04 inches (1 millimeter).

In some other embodiments, the thickness of the at least one heating element is approximately 0.01 inches (0.25 millimeters).

In some other embodiments, the thickness of the heating blanket is less than 0.06 inches (1.5 millimeters).

In some other embodiments, the thickness of the heating blanket is approximately 0.015 inches (0.38 millimeters).

In some other embodiments, the heating blanket can be folded over on itself and an average radius of the fold is 0.045 inches (1.5 millimeters) or less.

In some other embodiments, the structured CNT layer comprises a carbon nanotube (CNT)-polymer film structure including single wall carbon nanotubes (SWCNTs) and a silicone, wherein the mass percentage of the SWCNTs within the CNT-polymer film can be selected from any value between and inclusive of at least about 0.25 to about 5 percent by weight, about 5 to about 10 percent by weight, about 10 to about 15 percent by weight, about 15 to about 20 percent by weight, and about 20 to about 25 percent by weight.

In some other embodiments, the mass of the SWCNTs within the CNT-polymer film can be selected from the group consisting of at least about 0.25 percent by weight of the CNT-polymer film, about 0.5 percent by weight, about 1 percent by weight, about 2 percent by weight, about 3 percent by weight, about 4 percent by weight, about 5 percent by weight, about 12 percent by weight, about 13 percent by weight, and about 25 percent by weight of the CNT-polymer film.

In some other embodiments, the CNT-polymer film structure comprises a constant uniform dispersion of the CNTs in the polymer comprising silicone and is between about 1 mm and about 2 mm in thickness. Further, the CNT weight percentage is about 3 percent to about 10 percent, resulting in a sheet resistance of about 70Ω/ to about 16Ω/, respectively.

In some other embodiments, the thickness of the CNT-polymer film structure is at least about 1 millimeter (mm), less than about 2 mm, or between about 1 mm and about 2 mm.

In some other embodiments, the thickness of the heating blanket is less than about 0.10 inches (2.54 millimeters) or less than about 0.20 inches (5.08 millimeters)

In some other embodiments, the heating blanket can be folded over and/or doubled over on itself, the mean or average radius of the fold approaching the thickness of the heating blanket.

In some other embodiments, the amount of heat produced by the heating blanket can be varied by varying at least one of the thickness of the CNT-polymer film structure, the percentage by weight of CNTs in the CNT-polymer film structure, the length of the CNTs in the CNT-polymer film structure, and the type of CNTs in the CNT-polymer film structure.

In some other embodiments, the average bundle size of the SWCNTs is between about 50 micrometers (μm) and about 300 μm and in an embodiment is at least one of 100, 150, and 175 μm in length.

In some other embodiments, the resistivity of the CNT-polymer film structure comprising SWCNTs in an average bundle length of 100 μm is about 5Ω/, about 6Ω/, about 7Ω/, about 14Ω/, about 36Ω/, about 43Ω/, about 46Ω/, about 47Ω/, about 58Ω/, about 288Ω/, about 450Ω/, about 750Ω/, and about 1,620Ω/; the resistivity of the CNT-polymer film structure comprising SWCNTs in an average bundle length of 150 μm is about 3Ω/, about 4Ω/, about 5Ω/, about 9Ω/, about 24Ω/, about 28Ω/, about 31Ω/, about 39Ω/, about 192Ω/, about 300Ω/, about 500Ω/, and about 1,080Ω/; and the resistivity of the CNT-polymer film structure comprising SWCNTs in an average bundle length of 175 μm is about 3Ω/, about 4Ω/, about 8Ω/, about 21Ω/, about 25Ω/, about 27Ω/, about 31Ω/, about 165Ω/, about 257Ω/, about 429Ω/, and about 926Ω/.

In some other embodiments, the resistivity of the CNT-polymer film structure comprising SWCNTs is at least about 3Ω/, at least about 5Ω/, at least about 10Ω/, at least about 20Ω/, at least about 30Ω/, at least about 40Ω/, at least about 50Ω/, at least about 60Ω/, at least about 70Ω/, at least about 80Ω/, at least about 90Ω/, at least about 100Ω/, at least about 200Ω/, at least about 300Ω/, at least about 400Ω/, at least about 500Ω/, at least about 600Ω/, at least about 700Ω/, at least about 800Ω/, at least about 900Ω/, at least about 1,000Ω/, at least about 1,100Ω/, at least about 1,200Ω/, at least about 1,300Ω/, at least about 1,400Ω/, at least about 1,500Ω/, or at least about 1,600Ω/.

In some other embodiments, the response to an applied electromotive force results in a power density of 1-10 watts per square inch (0.2-1.6 watts per square centimeter).

In some other embodiments, the amount of heat produced can be adjusted by varying at least one of the thickness, density, and structure of, and material used for the CNT structured layer.

In some other embodiments, the elastomeric outer covering is at least one of a fluoroelastomer (FKM), a silicone, a fluorosilicone, a perfluoroelastomer, an ethylene propylene diene rubber (EPDM), a thermoplastic elastomer, and a thermoplastic polyurethane (TPU) fluoroelastomer.

In some other embodiments, the elastomeric outer covering is a silicone rubber, and particularly selected from the group consisting of Airtech 4140 and Airtech 5553 silicon rubbers, and in a thickness selected from the group consisting of 0.030 and 0.060 inches (0.762 and 1.524 millimeters (mm)).

In some other embodiments, the carbon nanotubes (CNTs) of the structured CNT layer are single wall carbon nanotubes (SWCNTs).

In some other embodiments, the first and the second electrical terminals are electrically coupled to the CNT structured layer by at least one of crimping, an electrically conductive adhesive, an electrically conductive paste, a pressure fitting, a fastener, and a clamp.

In some other embodiments, the first and the second electrical terminals comprise an expanded metal foil.

In some other embodiments, the CNT structured layer and the electromotive force are selected to produce a debulking temperature in the range of 100-200° F. with a tolerance of +/−10° F. (38-93° C. with a tolerance of +/−6° C.).

In some other embodiments, the blanket further includes a plurality of heating elements connected in series.

In some other embodiments, the blanket further includes a plurality of heating elements connected in parallel.

In some other embodiments, the blanket further includes a plurality of heating elements connected in a series-parallel combination.

In some other embodiments, the CNT structured layer defines an electrically conductive pathway having a serpentine configuration.

In some other embodiments, the CNT structured layer defines an electrically conductive pathway having a serpentine configuration with at least one round corner.

In some other embodiments, the CNT structured layer defines an electrically conductive pathway having a serpentine configuration with at least one square corner.

In another embodiment, a method of debulking includes placing a plurality of a composite materials that are pre-impregnated with a resin, the resin including a curing agent, onto a mold tool, placing a heating blanket having a CNT structured layer over the plurality of composite materials, placing a flexible, air impermeable sheet over the plurality of composite materials on the mold tool, sealing the flexible, air impermeable sheet to the mold tool around the periphery of the plurality of composite materials, withdrawing air from between the flexible, air impermeable sheet and the mold tool, and applying an electromotive force to the heating blanket.

In some other embodiments, the method further includes increasing the electromotive force to cure the resin.

In some other embodiments, the method further includes applying a release agent to a surface of the mold tool that is to receive the composite materials.

In some other embodiments, the method further includes placing a porous film over the composite materials on the mold tool.

In some other embodiments, the method further includes placing a non-porous film over the composite materials on the mold tool.

In some other embodiments, the method further includes placing a breather fabric over the heating blanket.

In some other embodiments, the method further includes heating the composite materials to a debulking temperature in the range of 100-200° F. with a tolerance of +/−10° F. (38-93° C. with a tolerance of +/−6° C.).

In another embodiment, a method of debulking and/or curing, includes the steps of placing a plurality of dry fibers onto a mold tool, applying a resin to the dry fibers to wet the fibers, placing a heating blanket having a CNT structured layer over the wet fibers, placing a flexible, air impermeable sheet over the wet fibers on the mold tool, sealing the flexible, air impermeable sheet to the mold tool around the periphery of the wet fibers, withdrawing air from between the flexible, air impermeable sheet and the mold tool, and, applying an electromotive force to the heating blanket.

In yet some other embodiments, the debulking is performed without moving the composite materials into an autoclave.

In still other embodiments, the electromotive force is increased to cure a resin without moving the composite materials into an autoclave.

### BRIEF DESCRIPTION OF THE DRAWINGS

Various embodiments of a heating blanket are understood with regards to the following description, appended claims and accompanying drawings wherein:

FIG. 1 is an exploded perspective view of an in situ debulking layup including a heating blanket of the present invention.

FIG. 2 is a cross sectional illustration of the heating blanket shown in FIG. 1, taken along line 2-2, the heating blanket flattened out.

FIG. 3 is a cross sectional illustration of an alternative embodiment of a heating blanket shown in FIG. 1, taken along line 2-2, the heating blanket flattened out.

FIG. 4 is a graph showing the sheet resistances as a function of the weight percentage of single wall carbon nanotubes (SWCNTs) within a carbon nanotube (CNT)-polymer.

FIG. 5 is a schematic diagram of a heating blanket having a plurality of heating elements.

FIG. 6 is a diagram illustrating a CNT structured layer defining an electrically conductive pathway having a serpentine configuration with rounded corners.

FIG. 7 is a diagram illustrating a CNT structured layer defining an electrically conductive pathway having a serpentine configuration with square corners.

### DETAILED DESCRIPTION

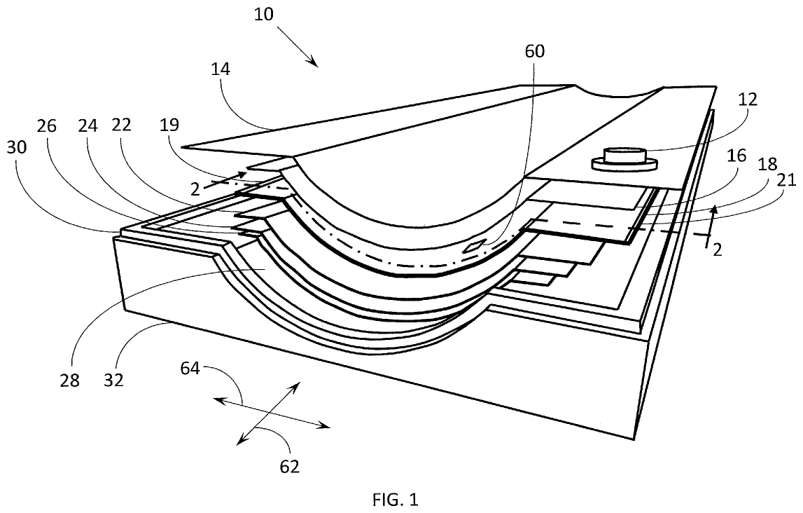

FIG. 1 illustrates an in-place or in situ debulking layup 10 including a heating blanket 18 in accordance with principles of the present invention. As used herein, “in situ” refers to debulking conducted in the location where a part or subpart is laid up, for example in a “clean” environment or in a cleanroom, free from foreign matter, and on the tool on which the laminate/part is laid up. When constructing component parts that require a high degree of structural integrity, such as aerospace parts, clean environments are typically used to ensure that foreign object debris, also referred to as FOD, is excluded from the laminate layup, which otherwise might compromise the structural integrity and/or strength of the parts being produced.

Conventionally, and without the benefit of the present invention, laminate prepregs of a subpart are typically laid up on a tool or mold, in a clean environment, and moved, along with the associated mold or tool, into an autoclave for debulking. In circumstances where parts have complex shapes and/or include many prepreg/laminate layers, the process of taking the tool and the laid-up prepreg laminates of the part to and from the autoclave must be repeated over and over again, each iteration having an associated duration of time and accompanying cost.

In the debulking layup 10 shown in FIG. 1, the blanket 18 provides heat to composite materials 26 laid up on the tool, for debulking the laminate in-place in the clean environment or in a cleanroom, i.e., in situ, without needing to move the composite materials 26 laid upon the mold tool 32 from the clean environment or location, to an autoclave. The heated debulking is conducted or occurs in place or “in situ,” on the tool 32, from the heat provided the heating blanket 18. Debulking, in accordance with the present invention, is more efficient in terms of both part-making time, scrap-rate, rework, and general economy (cost), and without the associated risks of introducing foreign objects into the laminate/composite material 26, or damaging the tool, when moving the subpart to and from an autoclave.

As shown in FIG. 1, debulking is accomplished through a combination of heat and pressure. Therefore, the present invention is configured or adapted for those debulking situations where just heat is used or where both heat and pressure are used. Again, the heating blanket 18 provides the heat necessary for heated debulking of the composite materials 26, while the atmosphere applies pressure to the composite materials 26 for pressurized debulking, as will now be described.

As illustrated in FIG. 1, a mold tool 32 is provided having the shape or the contour of a part that is to be made using composite materials 26. Typically, with aerospace parts, a mold tool follows the outer contour or windswept or windward side of the part, though this need not necessarily be the case. With other parts or in other embodiments, a mold tool can be made to follow an inner contour of a part should a particular circumstance dictate or need arise. Mold tools come in many shapes and sizes associated with the wide variety of parts made using composite or laminated materials. As shown, the mold tool 32 generally provides for a part that has a longitudinally convex shape. However, those of ordinary skill in the art will appreciate that the present invention is not limited to any particular part or mold tool shape, but rather applies universally to all in situ debulking layups.

Around the periphery of the mold tool 32, a vacuum sealant tape 30 has been secured. The vacuum sealant tape 30 is generally sealably affixed to the mold tool 32 and is configured to seal to a flexible, air impermeable film or sheet 14 that is placed over the mold tool 32. In use, a vacuum is created between the film 14 and the mold tool 32, as facilitated or provided by the seal of the vacuum sealant tape 30, by withdrawing air from between the film 14 and the mold tool 32, through a vacuum valve 12. The vacuum that is created between the film 14 and the mold tool 32 eliminated substantially all air within the vacuum space, which allows ambient air pressure or atmospheric pressure to press upon the composite materials 26, pressing the composite materials 26 against the mold tool 32, debulking the composite materials 26 using pressure.

As shown in FIG. 1, a number or plurality of uncured fiber reinforced composite materials 26, often referred to as “prepregs,” are placed or “laid up” on the mold tool 32. For example, prepreg is the term commonly applied to a carbon fiber fabric that has been pre-impregnated with a resin, typically epoxy, that already includes a suitable curing agent, and is ready to be laid into a mold. The layup 10 is typically done in accordance with a “build sheet” or a “part program,” designating the type, kind, orientation, and/or quantity of layers or composite sheets that are to be used to construct a part. For example, in the layup 10 shown, a number or plurality of prepreg carbon fiber sheets are used, some of which can be woven fabric and others of which can be non-woven fabric, typically vapor permeable. One of ordinary skill in the art will appreciate that any type of composite materials may be used, as desired, with the heating blanket 18, and that the present invention is not limited to any particular type or construction of composite materials. It should also be appreciated that this process can be applied to hand layup of dry fiber material, whereas the resin is applied (also by hand) during the laminate stack-up process.

Prior to placing the composite materials 26 on the mold tool 32, a release agent 28 is applied or sprayed onto a contoured surface of the mold tool 32 that is to receive the composite materials 26, as indicated a reference numeral 28. The release agent 28 is typically a clear substance (film or solution), although that need not necessarily be the case. The release agent 28 allows for the easy removal of the composite materials 26 after debulking and/or curing is complete.

In another embodiment, a porous film 24, typically referred as a peel ply, and a non-porous film 22, typically referred to as a release film, can be overlapped, respectively, over the laid-up composite materials 26, on the mold tool 32. The porous film 24 allows air or gas to percolate or pass from between and through the layers of the composite materials 26 during debulking, while the non-porous film 22 prevents resin, contained in the prepregs, from contacting the heating blanket 18 during debulking, thereby allowing for the release, for reuse, of the heating blanket 18 once debulking is complete. Once the non-porous film 22 is in place, the heating blanket 18 is placed over non-porous film 22, proximate the composite materials 26, so as to allow heat produced by the heating blanket 18 to warm the composite materials 26 during debulking. A breather fabric 16 is placed over the heating blanket 18 and allows uniform distribution and/or passage of air over the heating blanket 18 as air is extracted from between the bagging film 14 and the mold tool 32, i.e., a vacuum is applied to the debunking layup 10.

The heating blanket 18 includes at least two electrical terminals 19, 21 for use in electrically connecting or coupling the heating element(s) to an electromotive force. When electrically-coupled to an electromotive force, the heating blanket 18 produces electrothermal heat that warms or heats the composite materials 26. For example, in one embodiment, and when configured for use with carbon fiber prepreg materials, the heating blanket 18 heats the composite materials 26 to a debulking temperature of 100-200° F. with a tolerance of +/−10° F. (38-93° C. with a tolerance of +/−6° C.). One of ordinary skill in the art will appreciate that different composite materials having different resins, typically epoxies, can require different temperatures, and that the heating blanket 18 can be configured, as needed, to provide a debulking temperature associated with those thermoplastic or thermoset resins in accordance with principles of the present invention.

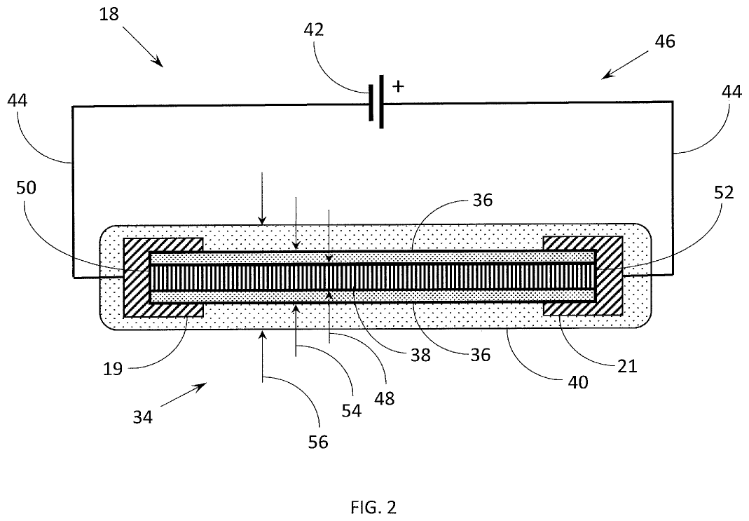

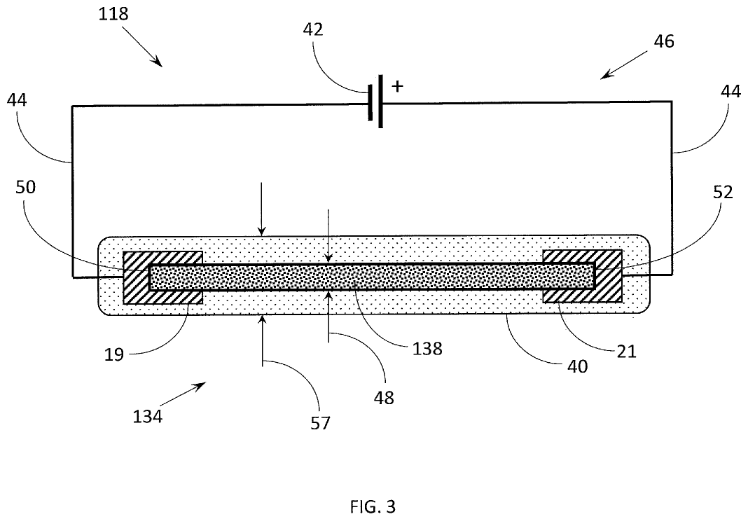

Referring to FIGS. 2 and 3, the heating blanket 18, 118, respectively, includes a heating element 34, 134, respectively, encased within an elastomeric outer covering 40. The heating element 34, 134, respectively, comprises a CNT structured layer 38, 138, respectively, defining an electrically conductive pathway having a first end 50 and a second end 52, and a first electrical terminal 19 electrically coupled to the first end 50 and second electrical terminal 21 electrically coupled to the second end 52. As shown in FIG. 3 and in a first process, the CNT structured layer 38 can be made in accordance with International PCT Publication WO 2016/019143 published on Feb. 4, 2016 and US Patent Publication US 2017/0210627 A1 published on Jul. 27, 2017 or U.S. Pat. No. 9,107,292 B2 granted on Aug. 11, 2015, said publications and patent incorporated herein by reference. In another embodiment, the CNT structured layer 38 can further comprise graphene.

In the first process for manufacturing the CNT structured layer 38 a continuous conveying belt is moved along a path that traverses a pooling region and a vacuum box, and a continuous porous carrier material is applied to an upper side of the continuous conveying belt. An aqueous suspension of CNTs dispersed in a liquid is applied on the porous carrier material. In an embodiment, the dispersed CNTs have a median length of at least 0.05 mm and an aspect ratio of at least 2,500:1, the aspect ratio referring to the length of the CNTs versus the width or diameter of the CNTs, e.g., length to diameter. A continuous pool of the aqueous suspension of the CNTs is formed over and across the width of the continuous porous carrier material in the pooling region, to a uniform thickness sufficient to prevent puddling upon the continuous porous carrier material. As the porous carrier material and the continuous pool of the aqueous suspension of the CNTs are advanced over the vacuum box, the liquid of the aqueous suspension of the CNTs is drawn by vacuum through the porous carrier material, thereby filtering a uniform dispersion of filtered CNTs over the porous carrier material to form a filtered CNT structure. Optionally any residual liquid from the filtered CNT structure can be dried to form a CNT sheet over the porous carrier material. Optionally the CNT sheet can be removed from the porous carrier material. In another embodiment of a process for manufacturing the CNT structured layer 38, carbon nanostructures that are branched, crosslinked, and that share common walls with one another are dispersed in a solvent until the carbon nanostructure are non-agglomerated. The solution is then passed through a support layer including a plurality of fibers, whereby the carbon nanostructures conform to the fibers and bridge across apertures or gaps between the fibers to form a continuous carbon nanostructure layer. In yet another embodiment of a process for manufacturing the CNT structured layer 38, a solution containing carbon nanostructures, that are branched, crosslinked and that shared common walls with one another, and chopped fibers are filtered to collect the carbon nanostructures on and between the fibers in a structured layer.

In one embodiment of the present invention, described hereinafter, the maximum quantity of heat, in terms of power per unit area, e.g., watts per square inch (centimeter), produced by the heating blanket 18 can be adjusted by varying the thickness 48 and therefore the electrical resistance of the structured CNT layer 38. In yet another embodiment of the present invention, the maximum quantity of heat produced by the heating blanket 18 can be adjusted by changing the CNT structure in the structured CNT layer 38, for example by using single wall carbon nanotubes (SWCNTs) or multi-walled carbon nanotubes (MWCNTs).

The heating element 34 further comprises a thermoplastic film 36 disposed against the upper and lower surface of the CNT structured layer 38. The thermoplastic film 36 adds durability and/or functions to protect the structured CNT layer. A carrier material, e.g., carbon fiber, fiberglass, thermoplastic veils, can also increase the durability and/or function to protect the structured CNT layer. The thermoplastic film 36 can also function to prevent the ingress of the molten or floury elastomer that forms the elastomeric outer covering 40, into the CNT structured layer 38 during application, thereby preventing the elastomeric outer covering 40 from raising the resistivity of the structured CNT layer 38. Although the ingress of the molten or floury elastomer into the CNT structured layer 38 raises the resistivity of the structured CNT layer 38, once the outer covering 40 cures, the heating blanket is still responsive to an electromotive force 42 and able to produce heat, albeit with higher resistivity.

Referring to FIG. 3 and in a second process, the CNT structured layer 138 can be made in accordance with International PCT Application PCT/US2017/045422 filed on Aug. 4, 2017, which claims the benefit of U.S. Provisional Application 62/370,712 filed on Aug. 4, 2016, both of which are incorporated herein by reference.

In the second process for manufacturing the CNT structured layer 138, a multiplicity of carbon nanotubes (CNTs), a polymer, and a solvent are mixed using sonication and, in some embodiments, shear mixing to form a CNT-polymer suspension of CNTs in a uniform dispersion within the polymer and solvent liquid. In some embodiments, the polymer comprises fluoroelastomers (FKM), silicones, fluorosilicones, perfluoroelastomers, ethylene propylene diene rubber (EPDM), and thermoplastic elastomers, such as, for example, thermoplastic polyurethanes (TPU). The CNT-polymer suspension is then applied onto a flexible carrier using a solvent cast coating process, a dip coating process, or a spray coating process. Heat is then directed to the applied CNT-polymer suspension and flexible carrier to heat the suspension and evaporate most, substantially all, or all of the solvent from the suspension, leaving the CNTs and polymer film to form a CNT/polymer film structure comprising a dispersion of the CNTs in the polymer structure upon the flexible carrier. The CNT-polymer film structure can then be removed from the flexible carrier, cut to size, and used as shown in FIG. 3 for the CNT structured layer 138.

A person of ordinary skill in the art will appreciate that the purpose of mixing the CNT-polymer suspension is to evenly distribute the CNTs within the suspension so that when the solvent is driven off and the suspension is dried, the resulting CNT-polymer film structure has substantially uniform resistivity throughout the entire film structure in the plane.

In some embodiments, the thickness of the CNT-polymer film structure is at least about 1 millimeter (mm), less than about 2 mm, or between about 1 mm and about 2 mm to facilitate an automated manufacturing continuous solvent cast coating process and to aid in or facilitate timely drying therein. The thicker the CNT-polymer film structure, the more drying time is required.

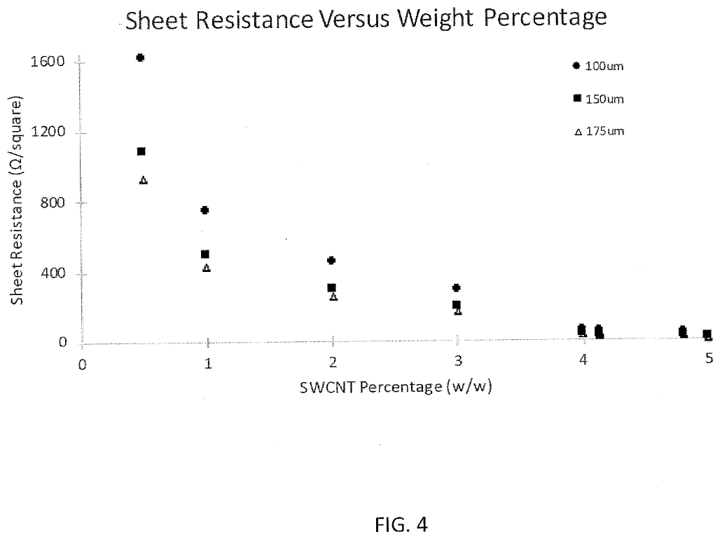

In a non-limiting example, the CNTs can be SWCNTs, the polymer can be a silicone, the solvent can be toluene, and the flexible carrier can be a polyether ether ketone (PEEK) film. Using the forgoing, a number of CNT-polymer film structures where made using a manual solvent cast coating process in a thickness of 100 micrometers (μm). For the CNT-polymer film structures made, FIG. 4 shows the sheet resistances (Ω/) as a function of the weight percentage (%) of SWCNTs within a CNT-polymer comprising silicone using three different batches of CNTs having three different CNT lengths, i.e., 100, 150, and 175 micrometers (μm) or microns, average bundle size. A person of ordinary skill in the art will appreciate that CNTs can be produced/purchased targeting a desired length, e.g., 100, 150, or 175 μm, but pragmatically, the actual length of each CNT will vary from one CNT to another, i.e., some CNTs being somewhat shorter and some CNTs being somewhat longer, a bundle of produced/purchased CNTs having an average length or an average bundle size. For example, SWCNTs in average bundle sizes of 100, 150, and 175 μm in length are available from OCSiAl headquartered in Grand-Duché de Luxemburg, and also in Columbus, Ohio. As used herein the term silicone refers to polysiloxanes, the terms used interchangeably. Polysiloxanes are polymers that include any inert, synthetic compound made up of repeating units of siloxane, which is a chain of alternating silicon atoms and oxygen atoms, combined with carbon, hydrogen, and sometimes other elements. As shown, the sheet resistance can be increased by using shorter length CNTs, other factors being equal, e.g., thickness, weight, etc. Conversely, the sheet resistance can also be decreased by using longer CNTs, again, other factors being equal, e.g., thickness, weight, etc.

The sheet resistance can be at least about 3Ω/, at least about 5Ω/, at least about 10Ω/, at least about 20Ω/, at least about 30Ω/, at least about 40Ω/, at least about 50Ω/, at least about 60Ω/, at least about 70Ω/, at least about 80Ω/, at least about 90Ω/, at least about 100Ω/, at least about 200Ω/, at least about 300Ω/, at least about 400Ω/, at least about 500Ω/, at least about 600Ω/, at least about 700Ω/, at least about 800Ω/, at least about 900Ω/, at least about 1,000Ω/, at least about 1,100Ω/, at least about 1,200Ω/, at least about 1,300Ω/, at least about 1,400Ω/, at least about 1,500Ω/, or at least about 1,600Ω/. A useful sheet resistance can be selected from any value between and inclusive of about 3 to about 1,600Ω/. Non-limiting examples of sheet resistances using SWCNTs in an average bundle length of 100 μm can include about 5Ω/, about 6Ω/, about 7Ω/, about 14Ω/, about 36Ω/, about 43Ω/, about 46Ω/, about 47Ω/, about 58Ω/, about 288Ω/, about 450Ω/, about 750Ω/, and about 1,620Ω/. Non-limiting examples of sheet resistances using SWCNTs in an average bundle length of 150 μm can include about 3Ω/, about 4Ω/, about 5Ω/, about 9Ω/, about 24Ω/, about 28Ω/, about 31Ω/, about 39Ω/, about 192Ω/, about 300Ω/, about 500Ω/, and about 1,080Ω/. Non-limiting examples of sheet resistances using SWCNTs in an average bundle length of 175 μm can include about 3Ω/, about 4Ω/, about 8Ω/, about 21Ω/, about 25Ω/, about 27Ω/, about 31Ω/, about 165Ω/, about 257Ω/, about 429Ω/, and about 926Ω/. The useful weight percentage of SWCNTs by weight of the CNT-polymer film structure can be selected from any value between and inclusive of about 0.25 to about 25 percent. For example, in a CNT structured layer including SWCNTs and a silicone, the mass percentage of the SWCNTs within the layer can be selected from any value between and inclusive of at about 0.25 to about 5 percent by weight, about 5 to about 10 percent by weight, about 10 to about 15 percent by weight, 15 to about 20 percent by weight, and about 20 to about 25 percent by weight. Non-limiting examples of percentages include about 0.25, about 0.5, about 1, about 2, about 3, about 4, about 5, about 12, about 13, and about 25.

In some embodiments, for a CNT-polymer film structure between about 1 mm and about 2 mm in thickness comprising a constant uniform dispersion of the CNTs in the polymer comprising silicone, a CNT weight percentage of less than about 15 percent proved workable without crumbling with handling, while a CNT weight percentage of about 20 percent, or more, was unusable, crumbling with handling, in some other embodiments, a CNT weight percentage of about 3 percent to about 10 percent resulted in a sheet resistance of about 70Ω/ to about 16Ω/, respectively.

Referring to FIGS. 2 and 3, and some embodiments, the elastomeric outer covering 40 is selected for use in a cleanroom, the heating blanket 18, 118, respectively, configured for use in situ. In other embodiments of the present invention, the elastomer covering 40 can be formed from fluoroelastomers (FKM), silicones, fluorosilicones, perfluoroelastomers, ethylene propylene diene rubber (EPDM), and thermoplastic elastomers, such as, for example, thermoplastic polyurethanes (TPU). One of ordinary skill in the art will appreciate that the elastomeric outer covering 40 can be selected from a variety of materials, natural and synthetic, as desired, depending on the use environment of the heating blanket 18, 118, respectively, without departing from the spirit of the present invention.

Still referring to FIGS. 2 and 3, and in some other embodiments, the elastomeric outer covering 40 is as silicon-based material that offers high reversion resistance and strength, and that can be used in composite laminating and bonding systems using vacuum, e.g., bagging or hydraulic pressure during curing or bonding. One silicon-based material is Airtech 4140 silicon rubber available from Airtech International, Inc. of Huntington Beach, Calif. Another silicon-based material is Airtech 5553 silicon rubber also available from Airtech International, Inc. It was found that in some applications, a heating blanket constructed using Airtech 4140 would undesirably wear over time and in repeated use during testing, the outer cover stretching or deforming. The fiberglass reinforcement found in Airtech 5553 combats this problem. Both these silicon-based materials are available in thicknesses of 0.030 and 0.060 inches (0.762 and 1.524 millimeters (mm)), the selection of which thickness depends on how flexible the blanket need be, and as will be discussed in further detail hereinafter. Those of ordinary skill in the art can select an appropriate covering material and thickness for a particular application with the benefit of the teachings contained herein.

The elastomeric outer covering 40 can be cured and/or formed so that the heating blanket forms a resilient three-dimensional shape that follows or mimics the shape of a caul tool associated with a part. The elastomeric outer covering 40 can also be cured and/or formed so that the heating blanket forms a resilient three-dimensional shape that follows or mimics the shape of part, be it an inner or outer contoured surface of a part. A heating blanket with a predisposed shape or contoured shape rather than a shape that is substantially planar in nature makes the heating blanket easier to work with and particularly suited for placing the heating blanket into tight radiuses or narrow crevices in a part or for more closely following, i.e., staying in contact with, transitions between concave and convex portions of a part. For example, a heating blanket can be formed to follow the shape of a caul tool, placed over the caul tool, and then the caul tool with the heating blanket disposed there over, can be placed or inserted into a tight radius area or narrow crevice in a part that is being laid-up to debulk and/or cure the composite materials forming the part. Further, and as another example, a heating blanket with a predisposed shape or contoured shape makes the heating blanket able to follow transitions between the outer surface of an aircraft, e.g., a wing, and an opening therein, e.g., an air intake or outlet. One of ordinary skill in the art will appreciate that the elastomeric outer covering 40 can be cured in a multitude of ways, as desired, to make the heating blanket easier to work with and use without departing from the spirit of the present invention.

Electrically coupled to the CNT structured layer 38, 138, respectively, are at least two electrical terminals 19, 21, each representing different electrical nodes 50, 52. In one embodiment of the present invention, the electrical terminals 19, 21 are electrically coupled to the CNT structured layer 38, 138, respectively, by crimping the terminals 19, 21 over an end or edge of the CNT structured layer. In some other embodiments, the electrical terminals 19, 21 comprise a metal foil or expanded metal foil, the expanded metal foil preferred for enhanced flexibility of the blanket. In other embodiments of the present invention, the electric terminals 19, 21 can be electrically coupled by alternative means without departing from the spirit of the present invention such as electrically conductive adhesives or pastes, or simply with pressure fittings, fasteners, or clamps that provide enough force against the CNT structured layer 38, 138, respectively, to maintain acceptably low contact resistance.

The electrical terminals 19, 21 of the heating element 34, 134, respectively, are electrically connected or coupled to an electromotive force 42, through wires 44, forming an electrical circuit 46. The heating element 34, 134, respectively, is responsive to the electromotive force 42, thereby generating heat. Further, by varying, adjusting, setting, or selecting, i.e., raising or lowering, the voltage potential provided by the electromotive force, the quantity of heat, in terms of power per unit area, e.g., watts per square inch (centimeter), produced by the heating blanket 18, 118, respectively, can be raised or lowered. In one embodiment of the present invention, the CNT structured layer 38, 138, respectively, and the electromotive force 42 are selected to produce heat to raise the temperature of the laminate to a debulking temperature, for example, to a temperature in the range of 100-200° F. with a tolerance of +/−10° F. (38-93° C. with a tolerance of +/−6° C.). In another embodiment, the electromotive force 42 provides a power density of approximately 1-10 watts per square inch (0.2-1.6 watts per square centimeter), see FIG. 1 at reference numeral 60, for example, such a selection being made to achieve a debulking temperature that softens, and debulks prepregged carbon fiber composite materials 26, without curing the resin contained therein. If more power is applied, the heating blankets described herein can heat the composite materials 26 enough to fully cure the resin, This affords use of the heating blanket 18, 138, respectively, for composite repair and out-of-autoclave curing. Moreover, by using a CNT structured layer 38, 138, respectively, of the present invention, the temperature and power density remains relatively constant and uniform across the length and width of the CNT structured layer 38, 138, respectively, designated at reference numerals 62 and 64, respectively, and shown in FIG. 1.

Still referring to FIGS. 2 and 3 and in accordance with one aspect of the present invention, the heating blanket 18, 118, respectively, comprised of a heating element 34, 134, respectively, comprised of a structured CNT layer 38, 138, respectively, is significantly thinner, and more flexible and drape-able, than a conventional metallic filament-based heat blanket. For example, using the first process for making the CNT structured layer 38, a thickness 54 of the heating element 34 can be less than 0.04 inches (1 millimeter) and, in one embodiment, the thickness 54 of the heating element 34 can be approximately 0.01 inches (0.25 millimeters), see FIG. 2. Further, a corresponding thickness 56 of the heating blanket 18, including the elastomeric outer covering 40, can be less than 0.045 inches (1.5 millimeters) and, in one embodiment, the thickness 56 of the heating blanket can be approximately 0.015 inches (0.38 millimeters). Using the second process for making the CNT structured layer 138, a thickness 57 of the heat blanket 118 is less than about 0.10 inches (2.54 millimeters) or less than about 0.20 inches (5.08 millimeters), see FIG. 3, the thickness of less than about 0.10 inches (2.54 millimeters) being based on a CNT polymer structure thickness, i.e., thickness 48, of about 1 mm (0.040 inches) and two layers of 0.030 inch (0.762 mm) elastomeric material that are cured together to form the elastomeric covering 40, and a CNT polymer structure thickness of about 2 mm (0.080 inches) and two layers of 0.060 inch (1.524 mm) elastomeric material that are cured together to form the elastomeric covering 40, respectively.

In other embodiments, a thickness of the heating blanket according to the present invention is at least 0.01 inch (0.25 millimeters), and up to about 0.40 inch (10.2 millimeters), which can include a thickness of at least 0.05 inch (1.3 millimeters), at least 0.10 inch (2.5 millimeters), or at least 0.15 inch (3.8 millimeters), or at least 0.20 inch (5.1 millimeters), or at least 0.25 inch (6.4 millimeters), and up to about 0.35 inch (8.9 millimeters), or up to about 0.30 inch (7.6 millimeters), or up to about 0.25 inch (6.4 millimeters). The heat blanket can be thinner, or thicker, than the indicated thickness.

The heating blanket 18, 118 is also quite flexible in nature. For example, in one embodiment, the heating blanket 18 can be folded over and/or doubled over on itself without “failure,” wherein the mean or average radius of the fold approaching or less than the thickness 56 of the heating blanket 18, e.g., 0.045 inches (1.5 millimeters) or less. In another embodiment, the heating blanket 118 can be folded over and/or doubled over on itself without “failure,” the mean or average radius of the fold approaching or less than the thickness 57 of the heating blanket 118, e.g., 0.10 inches (2.54 millimeters) or less, or 0.20 inches (5.08 millimeters) or less.

Additionally, the heating blanket is also quite durable. For example, the flexural strength of a material can be defined as the ability of the material to resist deformation under load. For materials that deform significantly but do not break, for example, the thermoplastic film 36, the load at yield, typically measured at 5 percent deformation divided by the strain of the outer surface, is reported as the flexural strength or flexural yield strength. The American Society for Testing Materials (ASTM) D790 standard provides a test geometry for the forgoing measurement. The analogous test to measure flexural strength in the International Organization for Standardization (ISO) system is ISO 178. Typical average flexural strengths and flexural moduli ranges for polymers, of which a thermoplastic film 36 is one, are from 40 to 270 Megapascals (MPa) and 0.7 to 7.5 Gigapascals (GPa), respectively. For example, in the embodiment shown in FIG. 2, the flexural strength of the CNT structured layer 38 is equal to or greater than the flexural strength of the thermoplastic film 36. These thicknesses, flexibility, and durability makes the heating blanket 18 generally suited to “follow” or “conform” to the surfaces and shapes found in aerospace component parts and, more particularly suited to, in situ debulking, as shown in FIG. 1. For in the embodiment shown in FIG. 3, the flexural strength of the CNT structured layer 138 is even greater still, not being limited by a thermoplastic film.

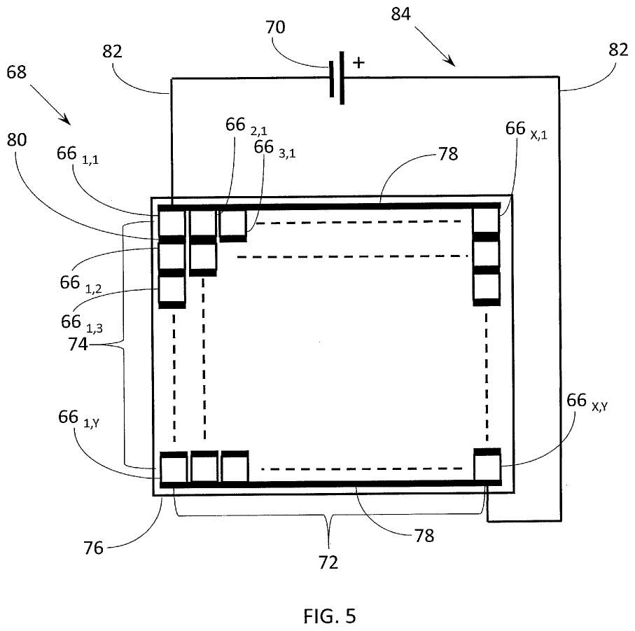

Referring now to FIG. 5, the scalability of a heating blanket 68 will be discussed. One of ordinary skill in the art will appreciate that composite parts can be so large that it is impractical or impossible to move them laid up on their accompanying mold into a suitably-sized autoclave for debulking; for example, the wing of a large passenger airplane. However, the scalability of the present invention provides for the debulking of such large parts as will be described below.

In accordance with another aspect of the present invention and as shown in FIG. 5, a plurality of heating elements 66_{X,Y} can be electrically and thermally combined to realize a heating blanket 68 that is physically larger than that typically afforded by a single heating element 66. As shown, a plurality of heating elements 66_{X,Y} are arranged in close physical proximity with one another, side-by-side, end-to-end, etc., in a planar arrangement. More specifically, physically adjacent, i.e., not overlapped, side-by-side, end-to-end, heating elements 66 can be electrically connected together to increase the physical, planar size of the heating blanket 68. For example, heating elements 66_{1,1} and 66_{1,2}, are electrically connected in series, the CNT structured layers of each heating element electrically coupled together through a terminal 80.

Similarly, heating elements 66_{1,1} and 66_{2,1}, are electrically connected in parallel, the CNT structured layers of each heating element likewise electrically coupled together through a terminal 78. It has been found that there is minimal temperature variation across the terminals 78, 80, and that a heating blanket 68 that is physically larger than that afforded by any of the heating elements alone, e.g., 66_{1,1}, 66_{1,2} or 66_{2,1}, can be realized.

Those of ordinary skill in the art will appreciate that although the heating elements 66_{X,Y} in FIG. 5 are shown as a matrix, the heating elements 66_{X,Y} are, in fact, electrically connected in a series-parallel circuit arrangement, the series heating elements designed by the variable “Y” as referenced by numeral 74 and the parallel heating elements designed by the variable “X” as referenced by numeral 72, the placement of each respective heating element designated as 66_{X,Y}. In some embodiments of the present invention, the series-parallel arrangement can be used to create “zones” in the heating blanket 68, each having different power densities and producing different amounts of heat to be applied to the laminate, as can be required by the complex shape of a mold tool, the mold tool acting as a heatsink with a varying heat profile.

Those of ordinary skill in the art will also appreciate that the electrical load, in terms of voltage and current, of the heating blanket 68 can be varied, as desired, in accordance with the electrical circuit arrangement, i.e., series-parallel combinations, of the plurality of heating elements 66_{X,Y}. The plurality of heating elements 66_{X,Y}, encased within the elastomer outer covering 76, are electrically connected or coupled to an electromotive force 70 via electrical terminals 78, such as through wires 82, forming an electrical circuit 84. The plurality of heating elements 66_{X,Y}, electrically connected in series, parallel, and/or a series-parallel combination, are responsive to the electromotive force 70, producing heat in response thereto. Further, by varying, adjusting, or setting, i.e., selecting, the voltage potential provided by the electromotive force 70, the heat produced by the heating blanket 68 can be varied proportionally.

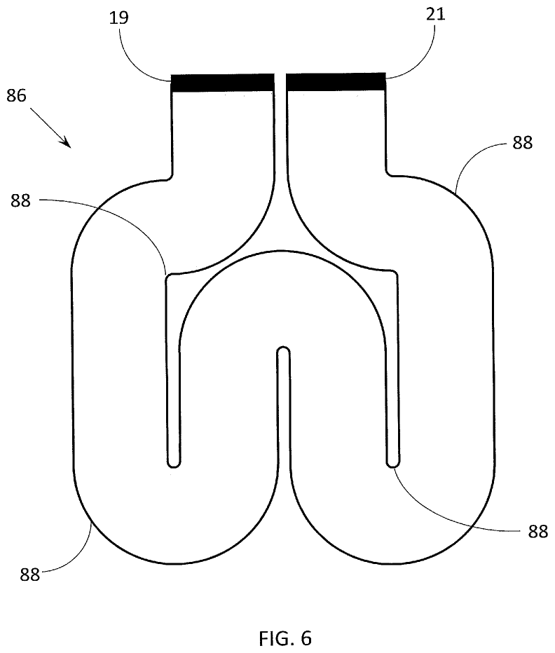

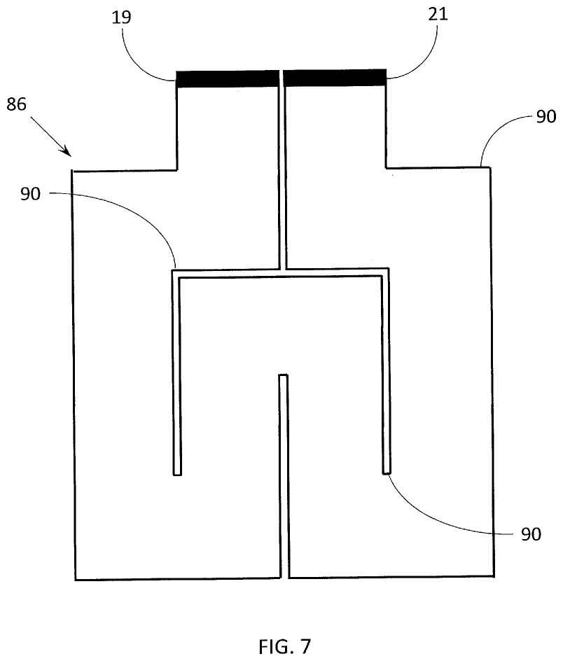

With reference to FIGS. 2, 3, 6, and 7, the CNT structured layer 38 can also be designed, manufactured, and/or constructed such that the electrical pathway defined by the CNT structured layer 38 is in a serpentine configuration 86. The serpentine configuration 86 allows for the first and the second terminals 19, 21 to be co-located, i.e., located in close proximity to one another or next to each other, to promote easy electrical connections thereto with good cable management. For example, the CNT structured layer 38 can be cut with a punch, a laser cutter, or by other means to form the serpentine configuration 86. FIGS. 6 and 7 show examples of serpentine configurations 86 with round corners 88 and square corners 90, respectively.

While various embodiments of a heating blanket have been illustrated by the foregoing description and have been described in considerable detail, it is not intended to restrict or in any way limit the scope of the appended claims to such detail. Additional advantages and modifications will become readily apparent to those skilled in the art.

1. A heating blanket, useful for debulking and/or curing composite materials, comprising:
at least one heating element comprising:
a carbon nanotube (CNT) structured layer defining an electrically conductive pathway having a first end and a second end; and,
a first electrical terminal electrically coupled to the first end and a second electrical terminal electrically coupled to the second end; and,
an elastomeric outer covering, encasing the at least one heating element;
wherein the at least one heating element is responsive to an electromotive force applied across the first and the second electrical terminals to produce heat.

2. The heating blanket of claim 1, wherein the elastomeric outer covering is cured so that the heating blanket forms a resilient three-dimensional shape that follows the shape of at least one of a caul tool associated with a part or a part that is to be produced.

3. (canceled)

4. (canceled)

5. (canceled)

6. (canceled)

7. The heating blanket of claim 3, wherein the thickness of the at least one heating element is between 0.25 millimeters (mm) and 5 mm.

8. (canceled)

9. (canceled)

10. (canceled)

11. (canceled)

12. The heating blanket of claim 1, the structured CNT layer comprises a carbon nanotube (CNT)-polymer film structure including single wall carbon nanotubes (SWCNTs) dispersed in a silicon structure, wherein the mass percentage of the SWCNTs within the CNT-polymer film can be selected from a value between and inclusive of at least about 0.25 to about 5 percent by weight, about 5 to about 10 percent by weight, about 10 to about 15 percent by weight, about 15 to about 20 percent by weight, and about 20 to about 25 percent by weight.

13. The heating blanket of claim 12, wherein the mass of the SWCNTs within the CNT-polymer film can be selected from the group consisting of at least about 0.25 percent by weight of the CNT-polymer film, about 0.5 percent by weight, about l percent by weight, about 2 percent by weight, about 3 percent by weight, about 4 percent by weight, about 5 percent by weight, about 12 percent by weight, about 13 percent by weight, and about 25 percent by weight of the CNT-polymer film.

14. The heating blanket of claim 12, wherein the CNT-polymer film structure comprising a constant uniform dispersion of the CNTs in the polymer comprising silicone is between about 1 mm and about 2 mm in thickness and the CNT weight percentage is about 3 percent to about 10 percent, resulting in a sheet resistance of about 70Ω/ to about 16Ω/, respectively.

15. The heating blanket of claim 12, wherein the thickness of the CNT-polymer film structure is at least about 1 millimeter (mm), and less than about 2 mm.

16. The heating blanket of claim 12, wherein the thickness of the heating blanket is less than about 0.10 inches (2.54 millimeters), or less than about 0.20 inches (5.08 millimeters).

17. The heating blanket of claim 16, wherein the heating blanket can be folded over and/or doubled over on itself, the mean or average radius of the fold approaching the thickness of the heating blanket, without failure of the heating element.

18. The heating blanket of claim 12, wherein the amount of heat produced by the heating blanket can be varied by varying at least one of the thickness of the CNT-polymer film structure, the percentage by weight of CNTs in the CNT-polymer film structure, the length of the CNTs in the CNT-polymer film structure, and the type of CNTs in the CNT-polymer film structure.

19. (canceled)

20. The heating blanket of claim 12, wherein the resistivity of the CNT-polymer film structure comprising SWCNTs in an average bundle length of 100 μm is about 5Ω/, about 6Ω/, about 7Ω/, about 14Ω/, about 36Ω/, about 43Ω/, about 46Ω/, about 47Ω/, about 58Ω/, about 288Ω/, about 450Ω/, about 750Ω/, and about 1,620Ω/; the resistivity of the CNT-polymer film structure comprising SWCNTs in an average bundle length of 150 μm is about 3Ω/, about 4Ω/, about 5Ω/, about 9Ω/, about 24Ω/, about 28Ω/, about 31Ω/, about 39Ω/, about 192Ω/, about 300Ω/, about 500Ω/, and about 1,080Ω/; and the resistivity of the CNT-polymer film structure comprising SWCNTs in an average bundle length of 175 μm is about 3Ω/, about 4Ω/, about 8Ω/, about 21Ω/, about 25Ω/, about 27Ω/, about 31Ω/, about 165Ω/, about 257Ω/, about 429Ω/, and about 926Ω/.

21. The heating blanket of claim 12, wherein the resistivity of the CNT-polymer film structure comprising SWCNTs is at least about 3Ω/, at least about 5Ω/, at least about 10Ω/, at least about 20Ω/, at least about 30Ω/, at least about 40Ω/, at least about 50Ω/, at least about 60Ω/, at least about 70Ω/, at least about 80Ω/, at least about 90Ω/, at least about 100Ω/, at least about 200Ω/, at least about 300Ω/, at least about 400Ω/, at least about 500Ω/, at least about 600Ω/, at least about 700Ω/, at least about 800Ω/, at least about 900Ω/, at least about 1,000Ω/, at least about 1,100Ω/, at least about 1,200Ω/, at least about 1,300Ω/, at least about 1,400Ω/, at least about 1,500Ω/, or at least about 1,600Ω/.

22. The heating blanket of claim 1, wherein the response to an applied electromotive force results in a power density of 1-10 watts per square inch (0.2-1.6 watts per square centimeter).

23. (canceled)

24. (canceled)

25. (canceled)

26. (canceled)

27. (canceled)

28. The heating blanket of claim 1, wherein the first and the second electrical terminals comprise an expanded metal foil.

29. The heating blanket of claim 1, wherein the CNT structured layer and the electromotive force are selected to produce a debulking temperature in the range of 100-200° F. with a tolerance of +/−10° F. (38-93° C. with a tolerance of +/−6° C.).

30. (canceled)

31. (canceled)

32. (canceled)

33. (canceled)

34. (canceled)

35. (canceled)

36. A method of debulking and/or curing, comprising the steps of:
placing a plurality of a composite materials that are pre-impregnated with a resin, the resin including a curing agent, onto a mold tool;
placing a heating blanket having a CNT structured layer over the plurality of composite materials;
placing a flexible, air impermeable sheet over the plurality of composite materials on the mold tool;
sealing the flexible, air impermeable sheet to the mold tool around the periphery of the plurality of composite materials;
withdrawing air from between the flexible, air impermeable sheet and the mold tool; and,
applying an electromotive force to the heating blanket.

37. The method according to claim 36, further comprising increasing the electromotive force to cure the resin.

38. (canceled)

39. (canceled)

40. (canceled)

41. (canceled)

42. The method of claim 36, further comprising heating the composite materials to a debulking temperature in the range of 100-200° F. with a tolerance of +/−10° F. (38-93° C. with a tolerance of +/−6° C.).

43. (canceled)

44. A method of composite processing, comprising the steps of:
placing a heating blanket having a CNT structured layer over composite materials that at least one of contain a resin and are wetted with a resin; and,
applying an electromotive force to the heating blanket to debulk the composite materials.

45. The method of claim 44, wherein debulking is performed without moving the composite materials into an autoclave.

46. The method of claim 44, further comprising increasing the electromotive force to cure the resin without moving the composite materials into an autoclave.
